(19) United States
(12) Patent Application Publication
(10) Pub. No.: US 2009/0014134 A1
(43) Pub. Date: Jan. 15, 2009

(54) ENERGY EFFICIENT WINDOW SHADE

(75) Inventors: Michael Hanley, Smithfield, RI (US); Mary Woodhouse, Cranston, RI (US)

Correspondence Address: BARLOW, JOSEPHS & HOLMES, LTD., 101 DYER STREET, 5TH FLOOR, PROVIDENCE, RI, 02903, US

(73) Assignee: KENNEY MANUFACTURING COMPANY, Warwick, RI (US)

(21) Appl. No.: 12/171,808

(22) Filed: Jul. 11, 2008

Related U.S. Application Data
(60) Provisional application No. 60/949,531, filed on Jul. 13, 2007.

(51) Int. Cl. E06B 9/40

(52) U.S. Cl. 160/266

(57) ABSTRACT

An energy efficient shade assembly for a window is disclosed. The shade assembly includes a shade roller assembly having a roller with a shade attached thereto driven by a spring motor. Left and right brackets configured and arranged to be secured to a window casement and support a left and right ends of the shade roller assembly are included. Also include are left and right side rails depending from the brackets. Each side rail has a movable flap extending substantially the length thereof. The flaps of the side rails are configured and arranged to fold over a portion of the shade when the shade is drawn from the shade roller assembly.

### CROSS-REFERENCE TO RELATED APPLICATION

The present patent document claims priority to earlier filed U.S. Provisional Patent Application Ser. No. 60/949,531, filed on Jul. 13, 2007, the entire contents of which are incorporated by reference herein.

### BACKGROUND OF THE INVENTION

1. Field of the Invention

The present invention relates generally to window shades and more particularly to sealed window shades.

2. Background of the Related Art

In order to conserve home heating and cooling costs, it is desirable to reduce the heat lost or gained through the windows in homes and other buildings. Windows have long been a known problem with insulting the home from the outside environment on warm or cold days, respectively. To this end, window shades have been used to reduce the loss or gain of heat through windows. To improve upon window shades, sealed shades were created. Sealed shades generally include some means to attach the window shade itself to the window casement to further reduce the exchange of heat through the window. However, these prior art sealed window shades are not without problems. Prior art sealed window shades are often bulky and difficult to install. Further, these prior art sealed window shades lack aesthetics making them unappealing to install by home owners. Therefore, there is a perceived need for an improved sealed shade that is compact, easy to install and is also more aesthetically pleasing.

### SUMMARY OF THE INVENTION

The present invention solves the problem of the prior art by providing a sealed shade assembly that includes a shade roller assembly, a pair of telescoping side tracks or rails each having a sealing flap, a pair of uniquely configured brackets to retain the shade roller assembly in the window and aid in mounting the side tracks to the window casement. Each bracket also includes an outwardly extending shelf or mounting point for attaching an ornamental valance thereto to hide and shade roller assembly. The flaps are configured to fold over the shade when drawn from the shade roller assembly. Because the flaps can fold over the shade, draft from the window is reduced thereby conserving energy in the home.

### BRIEF DESCRIPTION OF THE DRAWINGS

These and other features, aspects, and advantages of the present invention will become better understood with reference to the following description, appended claims, and accompanying drawings where:

FIG. 1A shows a front view of a first embodiment of the shade in a window casement with the shade up;

FIG. 1B shows a front view of a first embodiment of the shade with the shade drawn;

FIG. 2 shows an exploded view of a first embodiment of the shade;

FIG. 3A shows an exploded view of a first embodiment of a valance;

FIG. 3B shows a perspective view of a second embodiment of a valance;

FIGS. 4A and 4B shows a perspective view and front view, respectively, of a left bracket for mounting the shade roller assembly to a window casement;

FIGS. 5A and 5B shows a perspective view and front view, respectively, of an alternative embodiment of a left bracket for mounting the shade roller assembly to a window casement;

FIGS. 6A and 6B shows a perspective view and front view, respectively, of a right bracket for mounting the shade roller assembly to a window casement;

FIGS. 7A and 7B shows a perspective view and front view, respectively, of an alternative embodiment of a right bracket for mounting the shade roller assembly to a window casement;

FIG. 8A shows a perspective view of the left telescoping side rail assembled, it being understood that the right telescoping side rail is the mirror image thereof;

FIG. 8B show an exploded view of the left telescoping side rail shown in FIG. 8A;

FIG. 9 shows an end view of the telescoping side rail; and

FIG. 10 shows an end view of an alternative embodiment of the telescoping side rail.

### DESCRIPTION OF THE PREFERRED EMBODIMENT

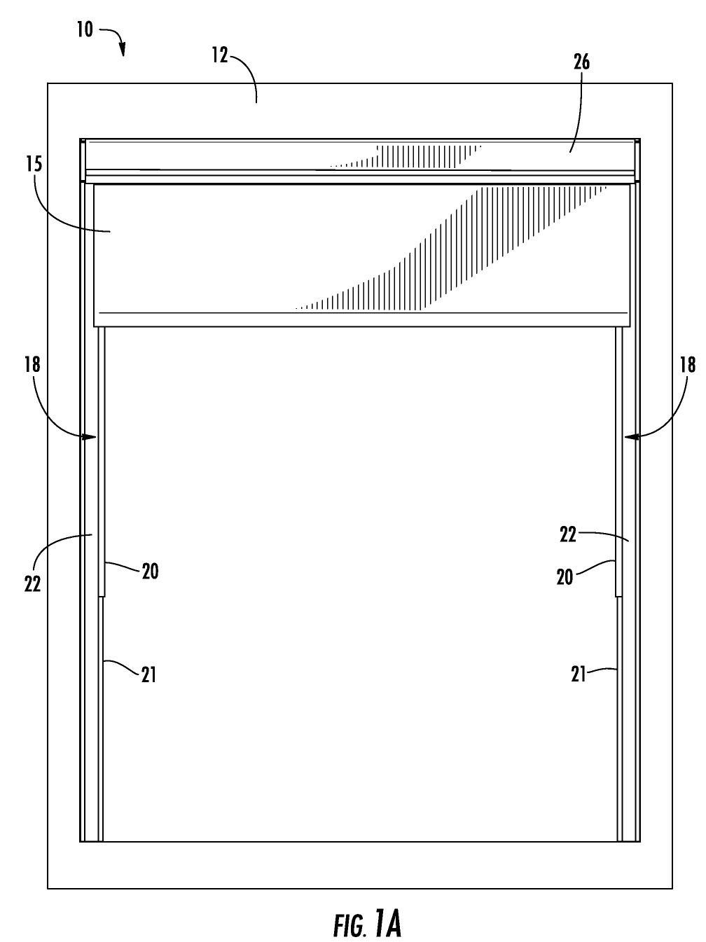

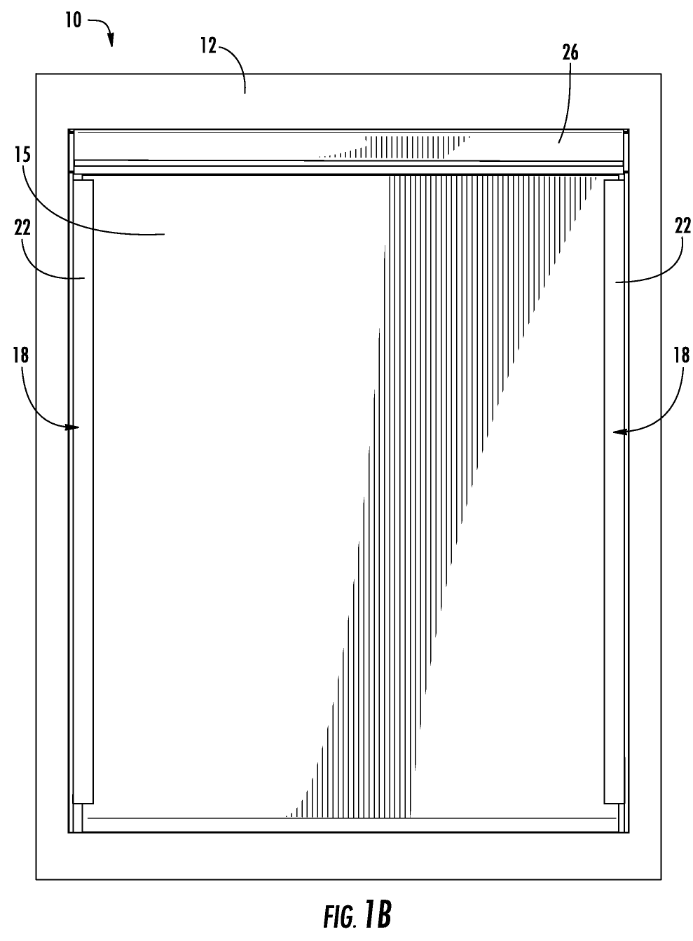

Referring to FIGS. 1A and 1B, the energy efficient shade assembly of the present invention is shown generally at 10 in a window casement 12. The energy efficient shade assembly 10 includes a number of different parts as seen in FIG. 2. Most importantly, the assembly 10 includes a spring-tension shade roller assembly 14 having a window shade 15. To retain the assembly 10 in a window casement 12, two brackets 16A, 16B are included; a left bracket 16A and a right bracket 16B. Also included is a pair of telescoping side rail assemblies 18. Each side rail assembly 18 is fastened to the window casement 12 and includes a pair of interlocking metal rails 20, 21 and a flap 22 with a magnet 24 attached thereto. The flap 22 is used to seal the shade 15 against the metal rails 20, 21 of the side rail assemblies 18, thereby reducing the draft or air flow between the window and the shade 10 and the interior of a home. Also a valance 26 is included to stop heat loss or gain from above the shade 15 at the top of the window. The valance 26 is frictionally fitted between a protrusion of the brackets 16 and the top of the window casement 12. Also to reduce draft, the valance fits above, in front, and below the shade roller assembly 14 and brushes up against the shade 15 material when the shade 15 is drawn down. The valance 26 also hides the shade roller assembly 14 and brackets 16A, 16B from view.

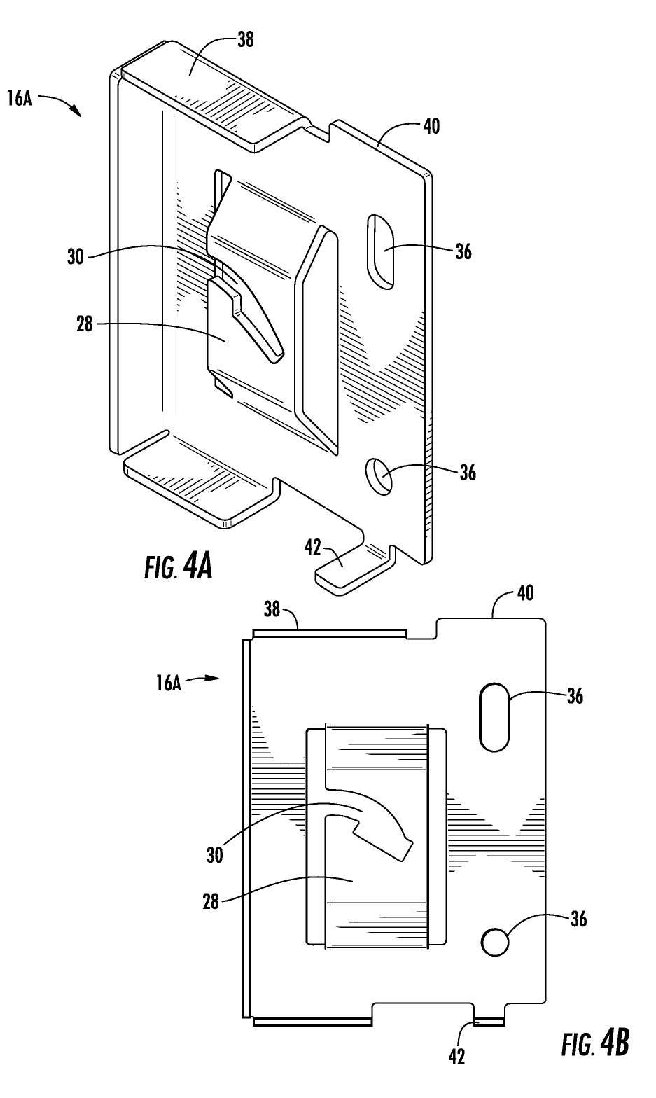

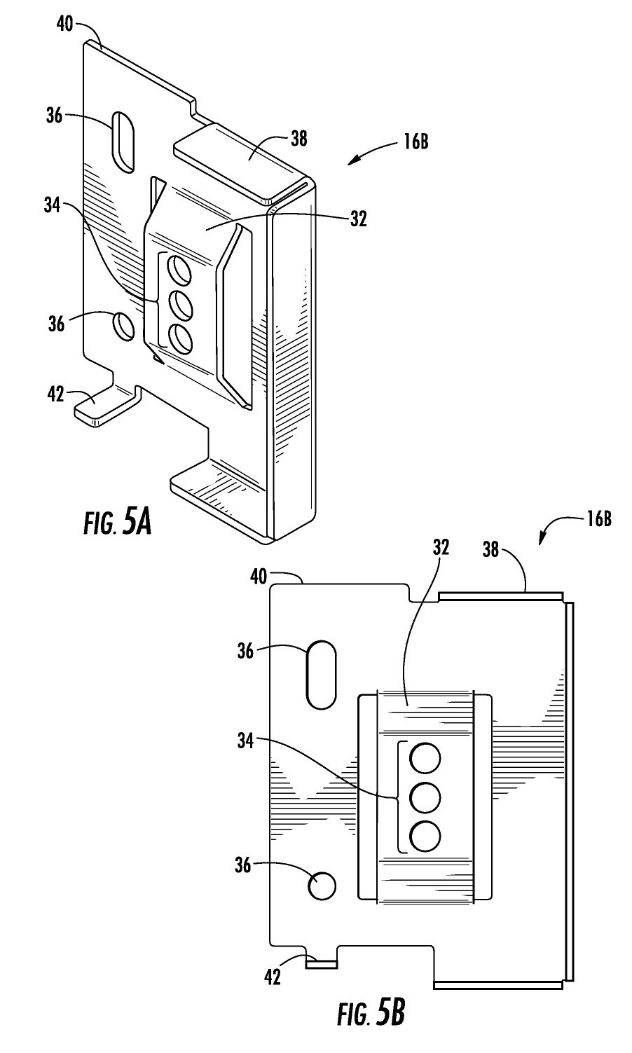

Referring now to FIGS. 4A, 4B, 5A, and 5B, an alternative embodiment of the brackets 16A, 16B are shown. The left bracket 16A includes a raised surface 28 with a slotted opening 30 to hold the tabbed end of the spring motor on the spring tension shade assembly 14. The right bracket 16B includes a raised surface 32 with one or more openings 34 to mount the other end of the spring tension shade assembly 14 therein. Each bracket 16A, 16B includes mounting holes 36 to permit the bracket 16A, 16B to be secured to the window casement 12. Preferably, one of the mounting holes 36 is slotted to permit final adjustment of the bracket 16A, 16B on the window casement 12 to level the shade roller assembly 14. Extending from the top of each bracket and perpendicularly therefrom is a mounting tab 38. The mounting tab 38 provides a mounting point for the valance 26 described further below.

A spacing tab 40 also extends from the top of each bracket 16A, 16B. During installation, the spacing tab 40 ensures that the bracket 16A, 16B is placed sufficient distance from the top of the window casement 12 to provide sufficient space for operation of the spring-tension shade 14 and attachment of the valance 26.

Extending from the bottom of each bracket is a hook 42. Each hook 42 cooperates with a hole on the top of the telescoping side rails 18 to assist in the installation of the of the shade assembly 10. In particular, the installer may hang the side rail 18 on the hook 42 after the bracket 16A, 16B has been installed in the window casement 12. The hook 42 assists the user in ensuring that the side rail 18 is properly aligned and spaced from the bracket 16A, 16B. Moreover, the hook 42 serves as a sort of third hand for the installer.

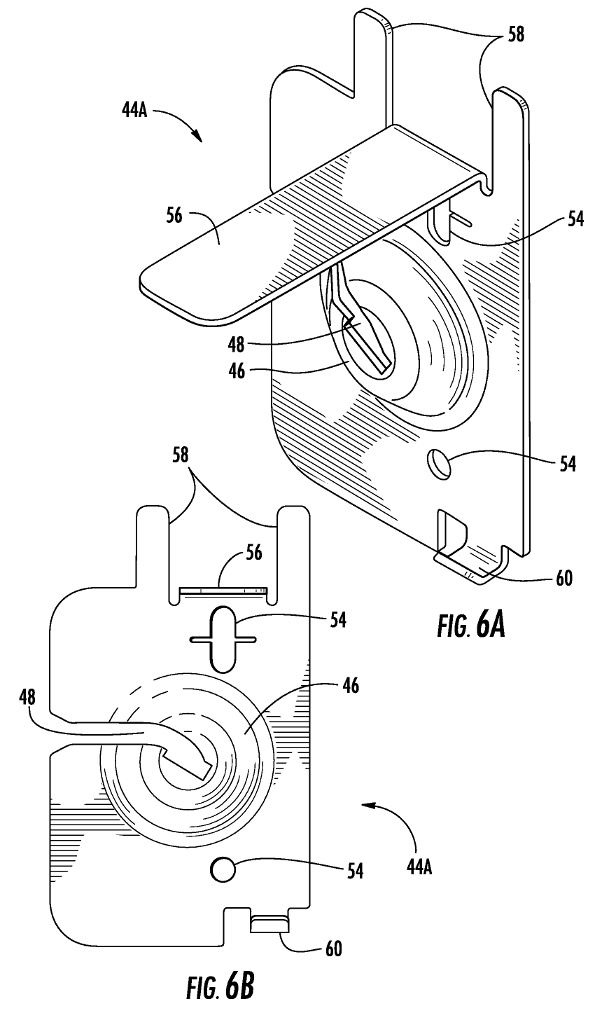

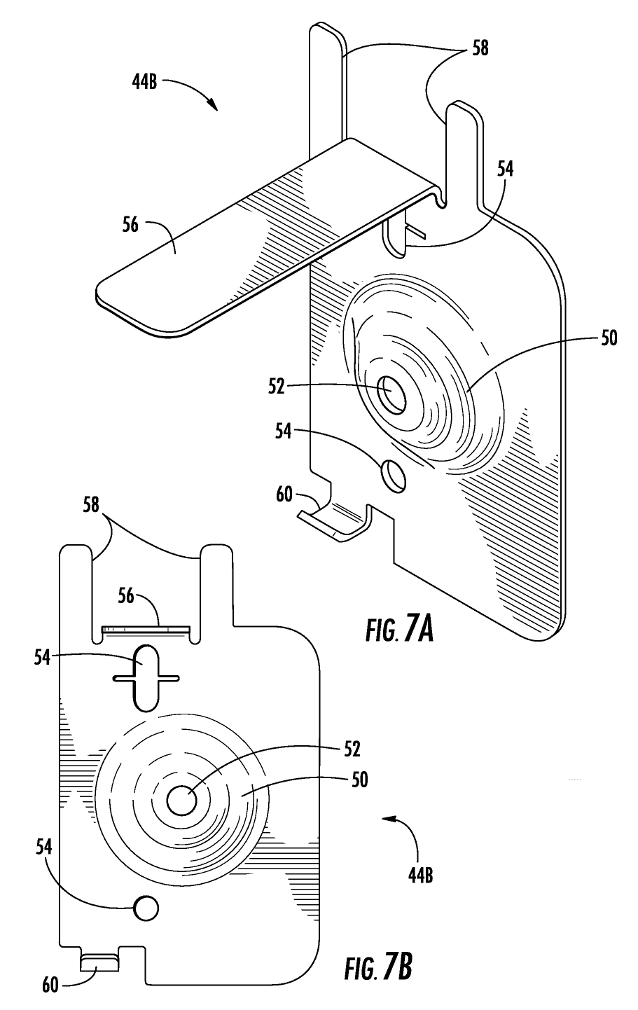

Referring now to FIGS. 6A, 6B, 7A, and 7B, an alternative embodiment of the brackets are shown 44A, 44B. The alternative left bracket 44A includes a raised surface 46 with a slotted opening 48 for the tabbed end of the spring motor on the spring tension shade assembly 14. The alternative right bracket 44B includes a raised surface 50 with an opening 52 to mount the other end of the spring tension shade assembly 14 therein. Each alternative bracket 44A, 44B includes mounting holes 54 to permit the bracket 44A, 44B to be secured to the window casement 12. Preferably, one of the mounting holes 54 is slotted to permit final adjustment of the bracket 44A, 44B on the window casement 12 to level the shade roller assembly 14. Extending from the top of each alternative bracket 44A, 44B and perpendicularly therefrom is a mounting tab 56. The mounting tab 56 provides a mounting point for the valance 26 described further below.

A pair of spacing tabs 58 also extends from the alternative bracket 44A, 44B and the mounting tab 56 is located therebetween. During installation, the spacing tabs 58 ensure that the bracket 44A, 44B is placed sufficient distance from the top of the window casement 12 to provide sufficient space for operation of the spring-tension shade 14 and attachment of the valance 26.

Extending from the bottom of each alternative bracket 44A, 44B is an upwardly curled hook 60. Each hook 60 cooperates with a hole on the top of the telescoping side rails 18 to assist in the installation of the of the shade assembly 10. In particular, the installer may hang the side rail 18 on the hook 60 after the bracket 44A, 44B has been installed in the window casement 12. The hook 60 assists the user in ensuring that the side rail 18 is properly aligned and spaced from the bracket 44A, 44B. Moreover, the hook 60 serves as a sort of third hand for the installer.

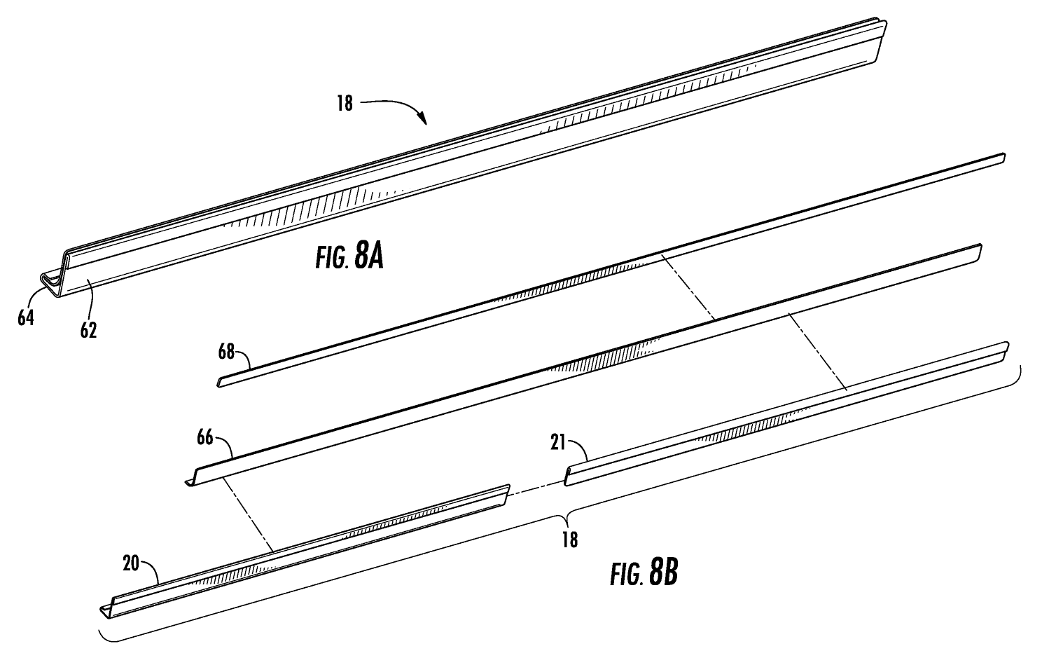

Referring now to FIGS. 8A, 8B and 9, each side rail 18 has an upper portion 20 and a lower portion 21, which slidably engage together and permit the side rail 18 to be shortened or lengthened as desired to fit the height of the window casement 12 that the shade assembly 10 is being installed in. Alternatively, each side rail 18 may be formed as a single piece for a particular window casement 12 size. The lower portion 21 of the side rail 18 is a roll-formed piece of sheet metal having a base wall 62 and a sidewall 64. The sidewall 64 extends perpendicularly from the base wall 62. The upper portion 20 of the side rail 18 is configured similarly to the lower portion 21; however, it is configured and arranged to slidably interfit with the lower portion 21, allowing the overall length of the side rail 18 to be adjustable by telescoping the upper portion 20 from the lower portion 21.

Both the upper portion 20 and lower portion 21 of the side rails 18 include holes therethrough to permit the sidewalls 64 to be fastened to the window casement 12 with self-taping screws, screws or other similar fasteners.

Attached to the sidewalls 64 is a flexible flap 66 with a magnetic strip 68 attached thereto. The magnetic strip 68 may be sewn or adhered to the flap 66 to prevent its removal. The outer end of the flap 66 is connected to the base wall 62 of the upper portion 20 of the side rail 18 and permits the flap 66 to be lifted away from the base wall 62. The magnet 66, however, will tend to attach itself to the metal base wall 62. The flap 66 and magnetic strip 68 have a length equal that of the side rail 18 in its fully extended length. The installer of the shade assembly 10 may easily cut the flap 66 and magnetic strip 68 to the desired length during installation.

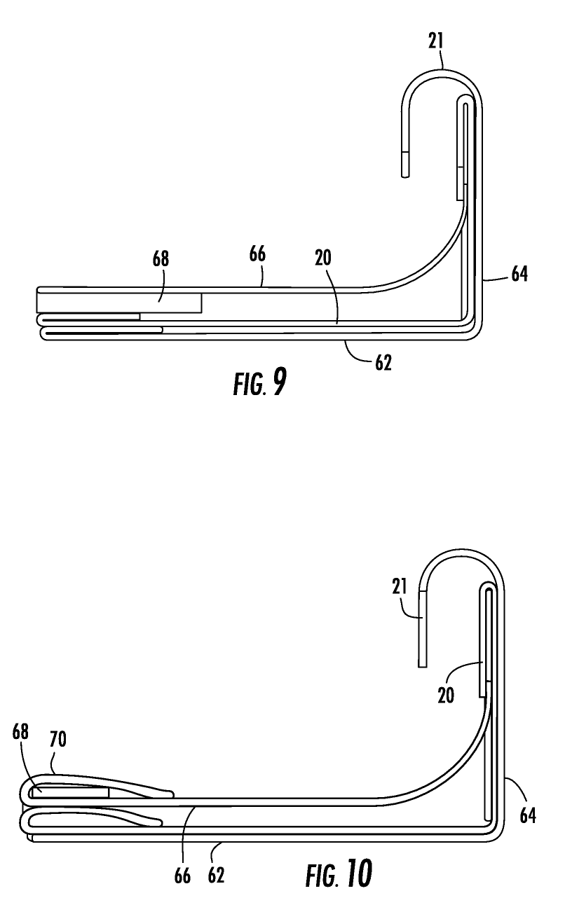

In an alternative embodiment, shown in FIG. 10, a sock or sleeve 70 if formed from the flexible material of the flap 66 to contain the magnetic strip 66. Specifically the flexible sock 70 is formed from a loop of the flexible material of the flap 66 and becomes a pouch for the magnetic strip 68. The magnetic strip 68 may be sealed therein to prevent its removal.

Once installed in the window casement 12, a user may operate the spring-tension shade roller 14 to extend the shade 15 to cover the window. After the shade 15 is deployed, the user may seal the shade 15 by, in turn, lifting the flap 66 on the left and right side rails 18 and placing the flap 66 over the shade 15. The magnetic strip 68 in the flap 66 will then attach itself to the metal base wall 62 of the side rail 18 by magnetism.

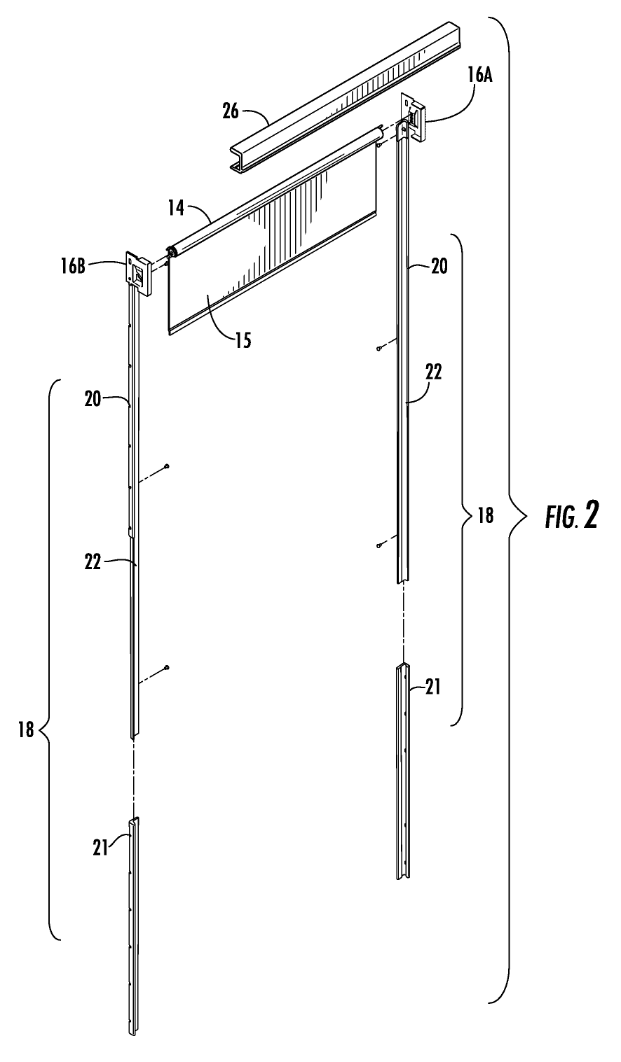

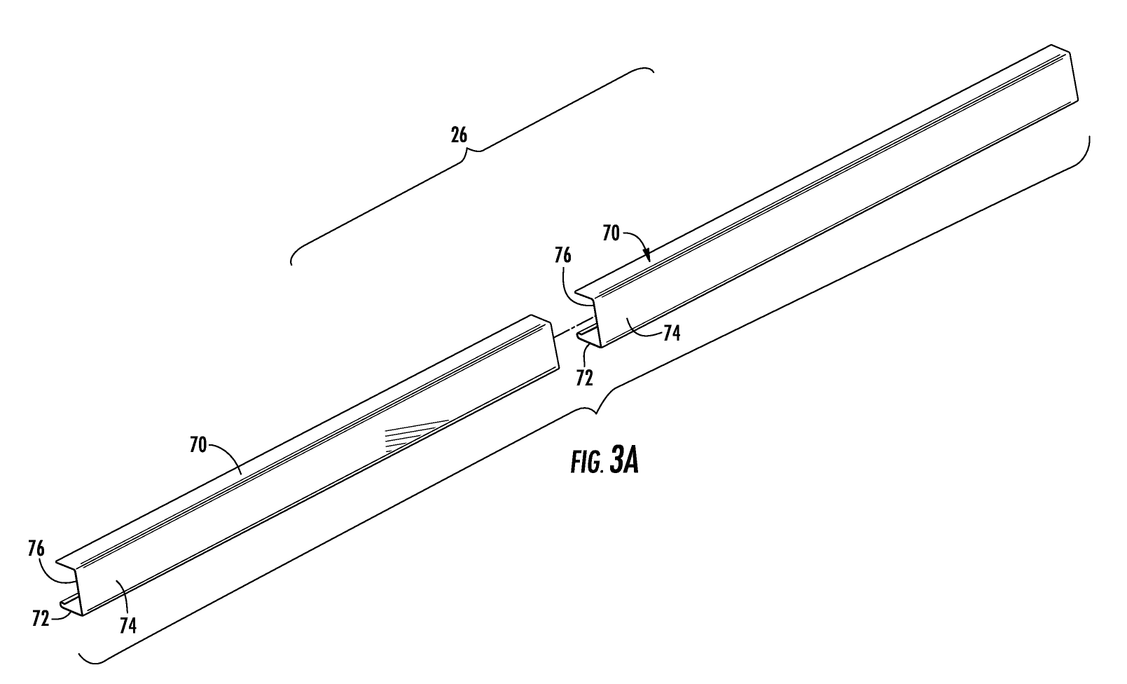

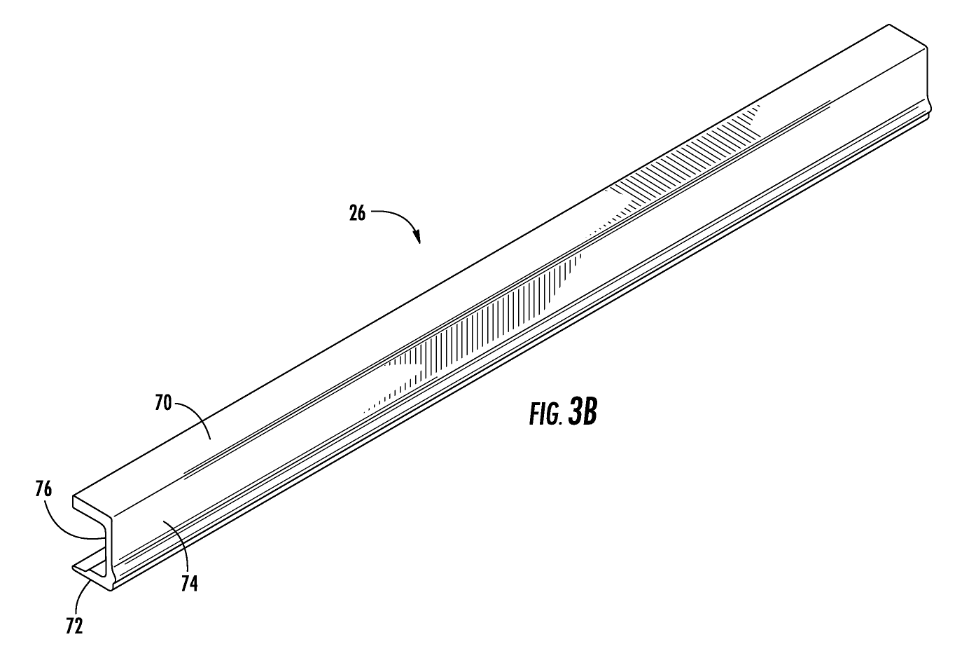

Referring back now to FIGS. 3A, 3B the optional valance 26 includes a top 70, bottom 72 and a front 74 wall configured and arranged to form a U-shaped (or C-shaped) channel 76 and cross-section. The valance 26 may be formed from two telescoping pieces as shown in FIG. 3A or as a single piece as shown in FIG. 3B. The front wall 74 has an exterior surface that may have decorative enhancements to improve the aesthetic appeal of the valance 26. The valance 26 is fitted over and around the spring-tension shade roller assembly 14 by frictionally fitting the top wall 70 of the valance 26 within the space formed between mounting tab 38 of the brackets 16A, 16B and the top portion of the window casement 12. The U-shaped channel 74 is configured to be large enough to permit operation of the spring-tension shade roller assembly 14 without undue interference, yet also hide the shade roller assembly 14 from view.

Therefore, it can be seen that the present invention provides a unique solution to the problem of providing am energy efficient shade assembly 10 that is compact and easy for a home owner to install. As can be appreciated, the energy efficient shade 10 will also reduce loss or gain of heat, respectively, through a window.

It would be appreciated by those skilled in the art that various changes and modifications can be made to the illustrated embodiments without departing from the spirit of the present invention. All such modifications and changes are intended to be within the scope of the present invention except as limited by the appended claims.

What is claimed is:

1. An energy efficient shade assembly, comprising:
a shade roller assembly having a roller with a shade attached thereto driven by a spring motor;
a left bracket configured and arranged to be secured to a window casement and support a left end of the shade roller assembly;
a right bracket configured and arranged to be secured to a window casement and support a right end of the shade roller assembly;
a left side rail depending from the left bracket, said left side rail having a movable flap extending substantially the length thereof;
a right side rail depending from the right bracket, said right side rail having a movable flap extending substantially the length thereof; and
said flaps of the left side rail and the right side rail, respectively, configured and arranged to fold over a portion of the shade when the shade is drawn from the shade roller assembly.

2. The assembly of claim 1, further comprising a valance supported by said left bracket and said right bracket and covering said shade roller assembly.

3. The assembly of claim 2, wherein said valance is telescopically adjustable.

4. The assembly of claim 1, wherein said flaps further comprise at least one magnet secured to each of said flaps.

5. The assembly of claim 4, wherein said at least one magnet is a continuous strip.

6. The assembly of claim 1, wherein said left side rail and said right side rail are telescopically adjustable.

7. An energy efficient shade assembly, comprising:
a shade roller assembly having a roller with a shade attached thereto driven by a spring motor;
a left bracket configured and arranged to be secured to a window casement and support a left end of the shade roller assembly;
a right bracket configured and arranged to be secured to a window casement and support a right end of the shade roller assembly;
a left side rail configured and arranged to be secured to a window casement below the left bracket, said left side rail having a movable flap extending substantially the length thereof;
a right side rail configured and arranged to be secured to a window casement below the right bracket, said right side rail having a movable flap extending substantially the length thereof; and
said flaps of the left side rail and the right side rail, respectively, configured and arranged to fold over a portion of the shade when the shade is drawn from the shade roller assembly.

8. The assembly of claim 7, further comprising a valance supported by said left bracket and said right bracket and covering said shade roller assembly.

9. The assembly of claim 8, wherein said valance is telescopically adjustable.

10. The assembly of claim 7, wherein said flaps further comprise at least one magnet secured to each of said flaps.

11. The assembly of claim 10, wherein said at least one magnet is a continuous strip.

12. The assembly of claim 7, wherein said left side rail and said right side rail are telescopically adjustable.

13. An energy efficient shade assembly, comprising:
a shade roller assembly having a roller with a shade attached thereto driven by a spring motor;
a left bracket configured and arranged to be secured to a window casement and support a left end of the shade roller assembly;
a right bracket configured and arranged to be secured to a window casement and support a right end of the shade roller assembly;
a valance supported by said left bracket and said right bracket and covering said shade roller assembly;
a left side rail depending from the left bracket, said left side rail having a movable flap extending substantially the length thereof, said flap having at least one magnet secured thereto;
a right side rail depending from the right bracket, said right side rail having a movable flap extending substantially the length thereof, said flap having at least one magnet secured thereto; and
said flaps of the left side rail and the right side rail, respectively, configured and arranged to fold over a portion of the shade when the shade is drawn from the shade roller assembly.

14. The assembly of claim 13, wherein said valance is telescopically adjustable.

15. The assembly of claim 13, wherein said at least one magnet is a continuous strip.

16. The assembly of claim 13, wherein said left side rail and said right side rail are telescopically adjustable.
